(19) United States
(12) Patent Application Publication
(10) Pub. No.: US 2005/0105527 A1
(43) Pub. Date: May 19, 2005

(54) Secure communication system, comprising a local network such as ethernet, in particular on board an aircraft

(75) Inventors: Marc Vervust, Ruiselede (FR); Mark Hugaerts, Duffel (FR)

Correspondence Address: LOWE HAUPTMAN GILMAN & BERNER, LLP, 1700 DIAGNOSTIC ROAD, SUITE 300, ALEXANDRIA, VA, 22314, US

(73) Assignee: THALES COMMUNICATIONS BELGIUM S.A., Tubize (BE)

(21) Appl. No.: 10/498,938

(22) PCT Filed: Dec. 10, 2002
(86) PCT No.: PCT/FR02/04258

(30) Foreign Application Priority Data
Dec. 21, 2001 (BE) 20010837

(51) Int. Cl. H04L 12/56

(52) U.S. Cl. 370/390

(57) ABSTRACT

The present invention concerns a secure communication system comprising a local network, such as for example of Ethernet type. The system comprises a local network and terminals connected to that network and exchanging data packets. Each terminal includes a table storing the addresses of the groups of terminals with which it can communicate. A terminal which transmits a data packet over the network in multicast mode creates a multicast network address the bits of which, for example high-order bytes, have a given value and which comprises address of the group to which data packet is addressed, each terminal comparing address of the addressee group with content of its table once the network address has been transmitted over the network. The invention is in particular applicable to multifunction communication systems where it is necesssary to ensure high-level security in data transmission, for example for certain systems on board aircraft.

The present invention concerns a secure communication system comprising a local network, for example of the Ethernet type. It applies in particular to multifunction communication systems in which it is necessary to ensure a high level of security in the transmission of voice or data, as is the case for example for certain systems on board aircraft.

Systems for communications between several members of one and the same crew, on board aircraft for example, are known. In this case, the communications may also be extended to outside the aircraft. The various members of the crew will exchange information of different security levels between one another. Not all the addressees may receive all the information transmitted by a given operator. It is therefore important that the system should be able to separate the data as reliably as possible according to their level of confidentiality in order in particular that each operator may be sure that it is the authorized addressee who receives his message. Secure transfer of information is an essential aspect in this type of communication system, the addressee receiving the information intentionally or not.

One aim of the invention in particular is to allow reliable transmission of the data within a local communication network. Accordingly, the subject of the invention is a communication system comprising at least one local network and terminals connected to that network and exchanging data packets. Each terminal comprises a table storing the addresses of the terminal groups with which it can communicate. A terminal which transmits a data packet over the network in multicast mode creates a multicast network address the bits of which, for example the high order bytes, have a given value and which comprises the address of the group to which the data packet is addressed, each terminal comparing the address of the addressee group with the content of its table when the network address has been transmitted over the network.

Other features and advantages of the invention will emerge from the following description made with respect to the appended drawings which represent:

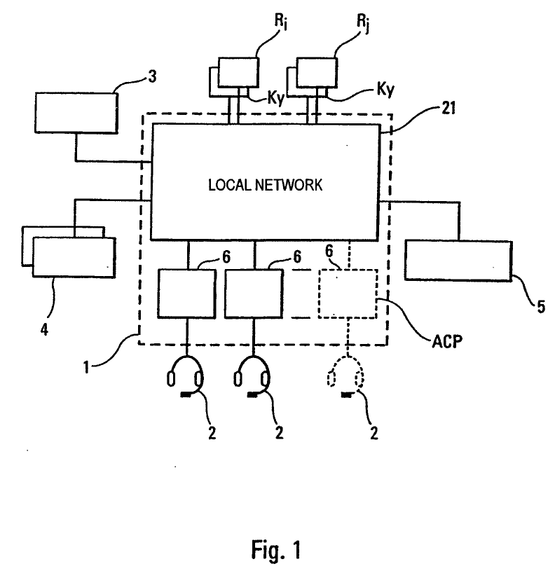

FIG. 1, a functional diagram of a system according to the invention;

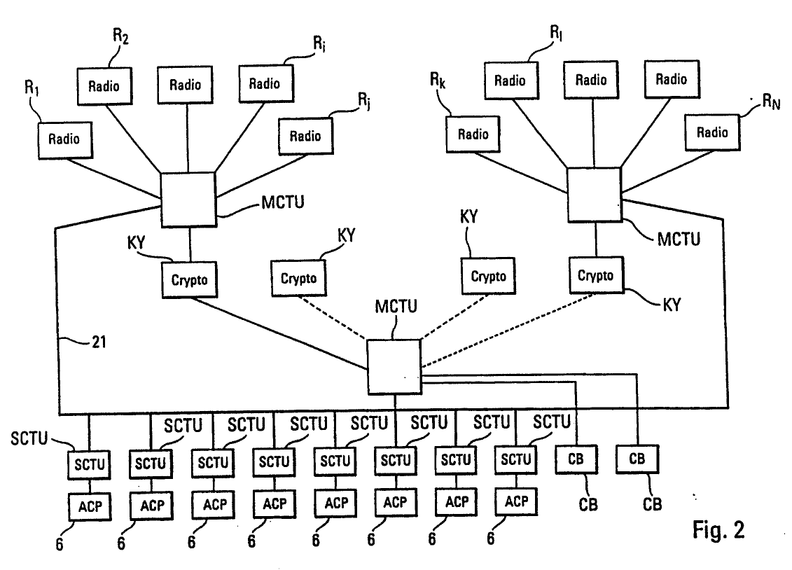

FIG. 2, a block diagram of a system according to the invention;

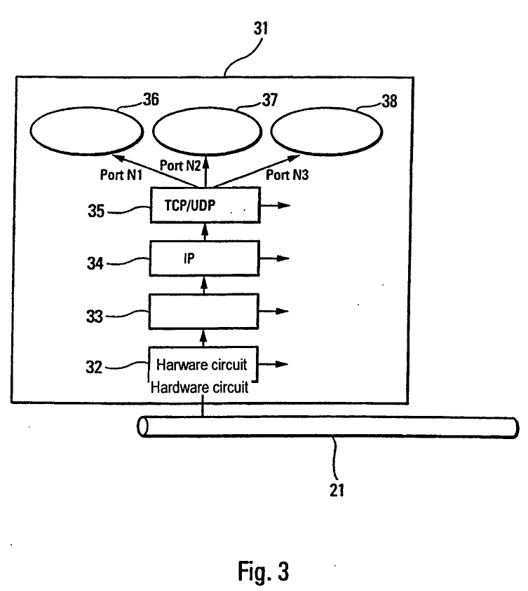

FIG. 3, an illustration of the software layers of a receiving terminal involved in the filtering of the data transmitted in the system;

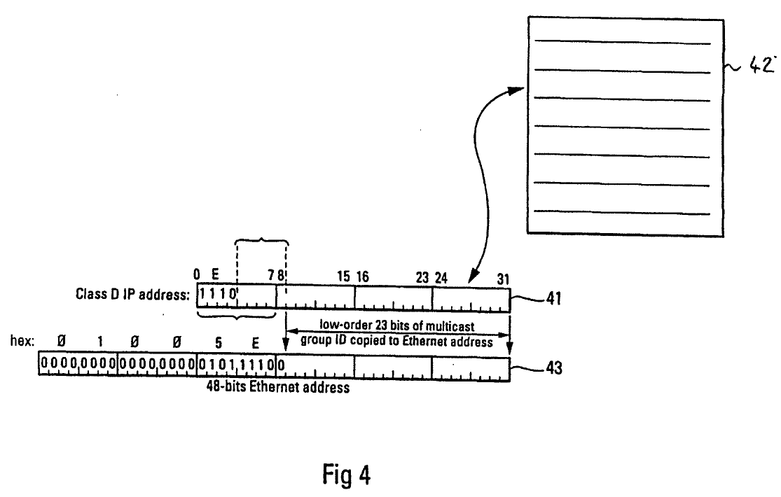

FIG. 4, an illustration of the data packet address mode used by a transmitting terminal;

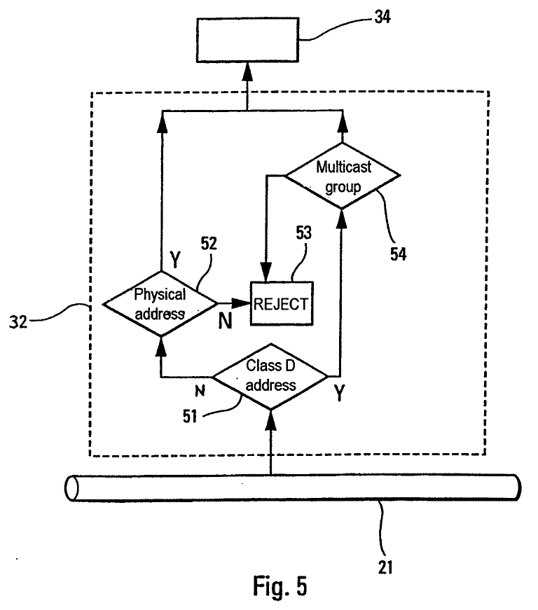

FIG. 5, an illustration of the transmitted packet address analysis performed by a receiving terminal;

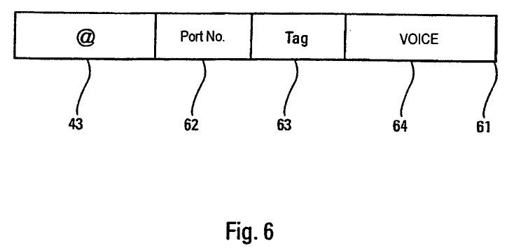

FIG. 6, an example of the structure of a data packet transmitted by a transmitting terminal;

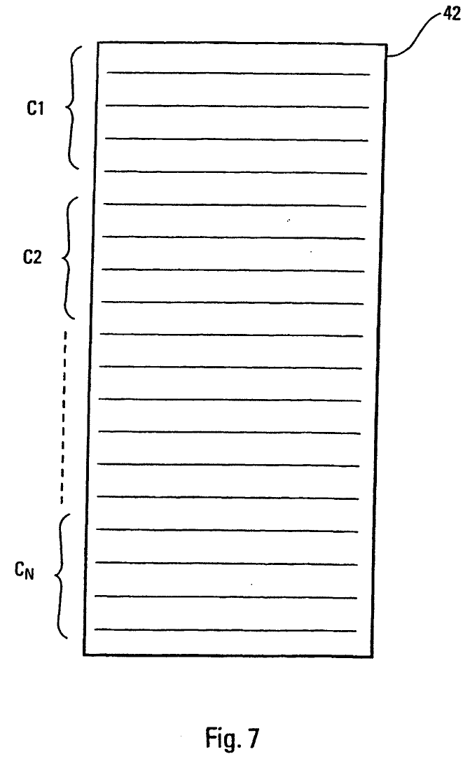

FIG. 7, an example of classification of addresses in a table associated with each terminal of the system.

FIG. 1 shows a functional diagram of a system 1 according to the invention. It allows several operators to communicate, in particular at several levels of security, and to exchange several types of information, voice or non voice. These operators are for example the members of an aircraft crew.

This system 1 interconnects several radio communication elements Rᵢ, Rⱼ, 2. These elements are for example stations such as radio receivers and radio transmitters or are for example headphone/microphone sets 2 incorporated in particular into helmets. The system 1 may also connect for example these elements to recording means 3, to data processing means 4, to command means 5 particularly for maintenance. It can also be used to connect to all these elements encryption means KY in order to protect certain sensitive data, these data representing a voice or any other information, digitized or not, during communications or information exchanges.

The system 1 comprises in particular a local network 21, for example of the high bit rate LAN type, the nodes of which comprise transceiver units which are connected to these elements Rᵢ, KY, 2, 3, 4, 5 directly or via interfaces. These units comprise means such as for example address and communication protocols which are used to direct the data from one group of elements to another group of elements.

FIG. 2 illustrates in a block diagram the above system 1, the latter being for example a multifunction communication system between several operators.

The system comprises at least multichannel terminals MCTU and single channel terminals SCTU situated at the nodes of the network 21. It also comprises command and control interfaces 6. These interfaces 6 may be more or less elaborate. The MCTU units are connected to radio stations R₁, . . . R_{N}, to encryption means KY, and for example to maintenance means not shown. An MCTU multichannel terminal may be connected to several elements of the radio station type or encryption means for example. The SCTU units are connected to the command and control interfaces 6. One SCTU unit and one interface 6 may for example be combined in one and the same box. The SCTU units are furthermore for example connected to audio headsets and microphones, or any other audio or visual communication means. A command and control interface 6 is an elaborate man-machine interface, for example a control panel comprising a touch-sensitive screen and various buttons by which an operator can select his communication channels. The interface 6 therefore connects the MCTU and SCTU units to audio communication means of the microphone or headset type, but also to control means of the aforementioned button or touch-sensitive screen type. It is therefore for example coupled to a command station.

The system 1 may also communicate with simplified CB interfaces. Such a CB interface is for example a basic man-machine interface intended for an operator, this interface being connected directly to an MCTU unit. It comprises an audio interface which may be either a headset or a microphone or any other means of communication. A CB interface accesses the system via a specific communication channel connected to an MCTU unit. In particular, it does not access an MCTU unit via the local network 21.

An MCTU multichannel terminal unit is therefore interfaced with a certain number of analog and digital channels connected in particular to the radio stations Rᵢ and the encryption means KY. An analog channel, hereafter called the audio channel, consists of a bidirectional line and a certain number of discrete inputs/outputs providing a control of the transmissions and receptions. The channel is also called “full duplex” in the English literature because communications may occur simultaneously in one direction and the other. A digital channel, hereafter called the data channel, consists of a bidirectional line of the “full duplex” type with discrete inputs/outputs to provide a control of the transmissions and receptions. Each MCTU is thus interfaced with the local network 21 by an appropriate circuit. This circuit is commanded by a software layer. Likewise, each SCTU unit is interfaced with the network 21 via such a circuit. In this way, the local network 21 interconnects all the MCTU and SCTU units. It transports all the audio, digital or control data across the whole system.

An MCTU unit in particular performs analog-digital and digital-analog conversions for all the audio channels that are interfaced with it. It converts and routes the input data from a data channel to the network 21. Conversely, it converts and routes the data from the network to the data channels. All the data entering an MCTU unit, whether they are audio or digital, but also the addresses, are for example automatically assigned a tag depending on their security level. In this way, a data element may be recognized in secure manner and used by an appropriate receiver of the network 21. In particular, two security levels should be considered, one level known as red and another level known as black. If the security level of a signal, a digitized voice or data, is red, this signal will be assigned a first type of tag, called red. If the security level of a signal, a digitized voice or data, is black, this signal will be assigned a second type of tag, called black. It should be noted that the assignment of tags is not limited to red or black tags but may also be extended to other security levels.

An SCTU single channel terminal unit constitutes in particular an input node or an output node of the local network 21 for the audio signals, representing particularly the voices of the various operators. It therefore forms an audio input/output for the system 1. An SCTU unit thus comprises, via a control interface 6, a link with an audio interface which may for example be an audio headset, a microphone or an oxygen mask. The SCTU unit comprises for example a second channel intended for an observer. This second channel is not a separate data channel, but originates from an analog multiplexing before digitization of the signals. As for the MCTU unit, an analog channel, hereafter called the audio channel, consists of a bidirectional line of the “full duplex” type and a certain number of discrete or nondiscrete inputs/outputs supplying a control of the transmissions and receptions. The control information is in particular supplied by the associated interface 6. This information depends for example on the requested security level and on the addressees or transmitters of the messages. As has been indicated previously, an SCTU unit is interfaced directly with the local network 21 via an appropriate circuit. In particular it performs the analog-digital and digital-analog conversions. It assigns to its incoming data a tag corresponding to their security level. An SCTU unit is connected to a control interface 6 via a serial bus. This bus is used only for the transfer of the control information, that is to say for the control and analysis of the commands sent to the interface 6 or originating from the latter. It does not contain voice information. The SCTU unit transfers in particular the data originating from the interface 6 to the local network 21.

Each node of the system, that is to say either an MCTU unit or an SCTU unit, is physically connected to the local network 21 by a digital integrated circuit known elsewhere, for example with microprocessor. This circuit comprises the inputs and outputs necessary for the transported data and for the various control information, including the hardware address of the circuit. The latter is for example connected to the network by means of a number of pairs of conductors, i.e. four conductors per connection, two of RX type and two of TX type. Other methods of connection to the network are of course possible.

One of the system nodes, an MCTU unit or an SCTU unit, acts as a server, in particular for starting up the system. Any MCTU or SCTU unit can play this role. This server contains the system database. When the server is started up, it updates the system database in all the nodes of the network, that is to say in all the MCTU and SCTU units. Thus each node has the same database and thus has access to the operational configuration of all the network. The system database is used to identify the authorized operations for each station, for example the communication channels that an operator can select via his or her command and control interface 6. When the operator makes a selection and for example presses a transmission command button, the audio message is sampled, that is to say it undergoes an analog-digital conversion by the SCTU unit connected to the interface 6. It is then for example processed to form a data packet of a certain length Δt. It is then transferred over the local network 21. The audio packet thus defined is then captured by the other MCTU, SCTU nodes of the network authorized to do so. Thus for example, if a user wants to speak to two radios Rᵢ, Rₖ at the same time, every Δt his or her station sends two successive audio digital signal packets over the network, one packet for the radio station Rⱼ and one for the radio station Rₖ. The header of a packet determines which is authorized to receive it, that is to say it comprises the address of the addressee or addressees. The system uses for example the TCP/IP and UDP/IP protocols to communicate in the local network 21. The protocol used has a stacked layer structure in which each layer provides a service to the layer immediately below it. A packet that is received via hardware means by a unit must then pass through each layer before being presented to the application which resides on the top layer of the stack.

Each layer filters the received packet so that the unauthorized packets are rejected as soon as possible. This is particularly necessary for security reasons. Accordingly, an address table is implemented in each MCTU, SCTU terminal. The Ethernet local network for example, uses six address bytes at the hardware level.

The IP (Internet Protocol) layer situated above the hardware interface layer uses four address bytes. Finally, the TCP and UDP protocols use for example port numbers to address a given process.

In a secure network, not all the transmitted data can go to any receiver. For example, this system is based on data of the red type and data of the black type, other security levels of course being able to be managed by a system according to the invention. In the configuration example in FIG. 2, certain data must be encrypted before transmission to radio stations. Accordingly, dedicated MCTU units are connected to encryption means KY; the latter are intended to route the red data which must be encrypted before transmission to the radio stations for example. Other MCTU units are directly connected to the radio stations and are intended to route the black data which require no encryption. An MCTU unit is either red or black in fixed manner over time. On the other hand, an SCTU unit may be red at one time and black at another. Encryption means KY are also connected to outside communication elements via an MCTU unit, or directly connected to communication elements not shown.

FIG. 3 illustrates how data filtering is applied at the level of each host component 31, every time a frame or packet travels over the local network 21. This component 31 is for example an MCTU unit or an SCTU unit. The first layer of filtering is carried out by the hardware circuit 32 associated with each unit, that is to say the circuit 32 directly connected to the local network 21. This connection circuit 32 may be called hereafter an Ethernet circuit to facilitate the description. Any other circuit 32 which is a network hardware interface may of course be used. This circuit 32 comprises a first software layer 33. Therefore, in a first step, the Ethernet circuit 32 analyzes the address of each packet traveling over the network. It acts in particular differently depending on whether the data packet and of the unicast or multicast type.

FIG. 4 illustrates the data packet address mode used in a system according to the invention, for a transmission of the multicast type. A multicast transmission allows the transmission of a data packet from a network node, in the present case an MCTU or SCTU unit, to a group of network nodes, that is to say to a set of MCTU or SCTU units. Each multicast group is identified by a specific address. Membership of a given multicast group is dynamic, that is to say that units can join or leave a group at any time. A unit may belong to several groups at a time. A unit does not need to be a member of a group to send data to the members of that group.

Multicast groups are for example identified by a class D address 41, corresponding to the TCP/IP protocol, that is to say by an address in which the four high order bits are 1110, forming the value E in hexadecimal. This address is coded on 32 bits. In Internet standard notation, the addresses of the multicast groups therefore occupy the space between 224.0.0.0 and 239.255.255.255. The address 224.0.0.0 is not for example used and the address 224.0.0.1 is for example reserved for the multicast group corresponding to all the MCTU and SCTU units. The addresses of the multicast groups are stored in a table 42, hereafter called the multicast table. This table 42 is present in each MCTU, SCTU unit, more particularly in its associated Ethernet circuit 32. An MCTU, SCTU unit is connected to the local network 21 via this circuit. At a given moment, the multicast table stored in a unit, or more particularly in its connection circuit 32, represents all the multicast groups to which that unit belongs. An address therefore corresponds to each multicast group and a channel corresponds to that address.

To be able to speak to a radio station or to a given conference network, a channel must be used. A channel is in fact a virtual connection which exists between an initiator of the channel, typically the operator activating his or her command and control interface 6, and one or more stations. A channel is identified by a unique number in such a way that it can be used inside the local network 21 without ambiguity. Thus, for example, when an operator activates his or her command and control interface 6 to communicate with a group of interlocutors, this interface 6 sends a message to its associated SCTU unit indicating to it the chosen channel number corresponding to the selected group. The channel number corresponds for example to the position of the multicast group address in the table 42.

The SCTU unit will therefore search in its multicast table 42 for the corresponding multicast group address and then create the multicast network address of the data packet which will be transmitted, this network address 43 being for example coded on 48 bits, as illustrated in FIG. 4. Accordingly, the 23 low order bits of the multicast group address 41 form the 23 low order bits of the network address 43. The following bit is not for example used and is set arbitrarily at 0 in the network address. Finally, the three high order bytes of the network address 43 are always set at one and the same value, for example an Ethernet address value coded in a hexadecimal base 01 00 5E. A network address beginning with this value 01 00 5E will be taken to be a multicast Ethernet address. The five bits of the multicast group address 41 between the 23 low order bits and the four high order bits forming the hexadecimal value E are not used, and therefore not inserted into the network address. For example, if a multicast group address has the value E1 55 55 55, its corresponding data will be transmitted with the network address 01 00 5E 55 55 55. In the example of creation of a network address 43 by a transmitting unit, it has been considered as an example that the transferred address was of the IP (Internet Protocol) type, particularly TCP/IP. Other types of protocols may of course be considered. Furthermore, this address has been transferred on 23 bits. It may obviously be transferred on another number N of bits, particularly according to the structure of the network and of the reception circuits.

Thereafter, the addresses are analyzed by the connection circuit 32 in accordance with FIG. 5. It is supposed that an SCTU unit sends a packet with a destination address. The Ethernet circuits 32 of the other units analyze this address as shown in FIG. 5. On Ethernet for example, the low order bit of the high order byte of the multicast address is set at 1. Thus, in a hexadecimal base, this address is of the type X1:XX:XX:XX:XX. The circuit 32 having verified that it is an Ethernet address, checks in a first test 51 that the network address 43 contains a class D multicast address 41, that is to say in accordance with the address creation previously described, that this network address begins with the value 01 00 5E. If this is not the case, it verifies in a subsequent test 52 that the received address corresponds to its physical address. If this is indeed the case, it means that it is the addressee of the message; the message is then processed by a subsequent software layer 34. In the contrary case, the message is rejected 53; it is not taken into account. If the first test 51 confirms that it is a multicast address, that is to say that the address begins with 01 00 5E, then the circuit 32 will verify by a subsequent test 54 whether it indeed belongs to the multicast group to which the message is sent. For this, it reconstitutes the multicast address via the operation that is the reverse of the one illustrated in FIG. 4, by extracting in particular the 23 low order bits. It then verifies that the multicast address thus obtained is contained in its multicast table 42. If it is, it indeed belongs to the addressee multicast group and the message is then processed by the subsequent software layer 34. This address will then be processed conventionally as a multicast address in the communication protocol which is for example of the TCP/IP or UDP/IP type. If the multicast address is not contained in the multicast table of the circuit 32, the latter rejects 53 the message.

Refer again to FIG. 3. Therefore, as a general rule, the Ethernet circuit 32 receives only the packets whose destination address corresponds either to its hardware address, or to a multicast group address contained in its table 42. This circuit is commanded by a software layer 33 which is the first of the stack of successive software layers which will filter the received messages. This first software layer 33 transmits the packets to the subsequent layer 34 which is for example an IP layer. This Internet protocol IP performs a filtering operation based on the source and destination addresses, and transmits the datagram to the subsequent layer 35 which is a TCP/IP or UDP/IP layer, if all is correct. Each time this latter layer 35 receives a datagram from the IP layer 34, it performs a filtering operation based on the destination port number, and where appropriate also on the source port number. There is therefore in this instance an additional filtering level which takes into account the port number of the transmission source. A system according to the invention is implemented in such a way that each channel has a unique multicast address, and also for example in such a way that each source unit, in particular the SCTU units, has a unique port number. This allows a receiving unit, at its last level software layer 35 for example, to determine the different sources for each channel. For a given channel, that is to say for a given multicast address, and a given source port number N1, N2, N3, etc., the software layer 35 of a receiving unit may thus activate a corresponding application 36, 37, 38. A specific process can therefore correspond to each channel-port number pair.

Another security level may be based on the type of information transmitted. As previously shown, this security level may be based on the red or black classification of the data. Accordingly, each packet sent comprises a tag whose value indicates whether the transmitted data are red or black. This tag does not necessarily give a binary information element, in particular it may assign to the transmitted data an information element other than the red or black type. This tag is generated by the transmitting unit. Analysis of the tag is in particular executed by the software layers of the receiving unit. Thus, if an MCTU unit receives a red message but is classified as black, it will reject the message.

FIG. 6 illustrates a typical data packet structure 61 generated by an SCTU unit in a system according to the invention. This packet comprises as a header the network address 43, the port number 62 of the transmitting unit, the tag 63 and the message 64. The address 43 is of the multicast type in the event of multicast transmission and so is for example equal to 01 00 5E XX XX XX. The port number 62 is coded on a number of bits compatible with the number of source units involved. The tag is coded on a number of data bits, for example 8 bits. Even if it defines only one binary state, for example the red or black qualification of the messages, it is more reliable than if coded on a number of bits greater than one. Finally the message itself 64 represents for example the coding of a voice message for a system of communication between operators. This message may indeed code any other type of information.

FIG. 7 illustrates an example of multicast group address classification in the multicast table 42 for filtering purposes, used in particular for reinforcing the filtering of the transmitted data. Since transmission security is important, it is advantageous to use several successive tests as has just been described. An additional test may be performed on the position of the multicast addresses in the multicast table 42 associated with each unit. This security level is here based on the position of the multicast addresses in this table 42 as described in FIG. 7. In other terms, the channels are classified in categories, the position of the multicast address of a channel in the table 42 being a function of its category. One zone of the table, separate or not, is associated with each category. The position of the multicast address is defined by its address in this table 42. The category may of course define a security level, for example red or black. FIG. 7 illustrates an arrangement of the multicast addresses in the table 42 according to their category. The addresses of the first categories occupy for example the first N boxes in the table, the addresses of the second category occupy the next M boxes and so on. A space of several unoccupied boxes may be left between two categories of addresses. In the case of a red and black security level, the red multicast addresses occupy for example the first N boxes and the black multicast addresses occupy for example the subsequent boxes. Advantageously, thanks to the arrangement of the multicast addresses in the table 42, a filtering operation can be carried out based on this arrangement. Thus, a black receiving unit which receives a multicast address arranged in the red zone of the table will reject the information. By combining for example this filtering operation with the other filtering operations, reliability on the security of information transmission is further increased; reliability on the separation of the red and black information is increased for example.

Referring again to FIG. 3, when the last software layer 35 of a receiving unit has confirmed that the received data is indeed addressed to that unit, by the application of one or more filtering operations previously described, it activates the application provided for that data. As an example, if the receiving unit is an MCTU unit, this application corresponds to the transmission of the data to encryption means if the MCTU unit is red or to a digital-analog conversion of the signal and its transmission to a radio station if the MCTU unit is black. In the rest of the various filtering operations carried out on the received data, alarms may be generated if a nonconforming data element passes through a first security level, typically a red data element received by a black unit.

A system according to the invention may be installed in an aircraft or on a ship for example. In this case, it allows in particular all the members of the crew to communicate with one another and with the outside on several security levels. The information exchanged in this case is voice messages but this information may in fact easily be other types of data. These data may be for example video data, written messages, figures, computer processes, etc.

The system has been described with MCTU multichannel terminals and SCTU single channel terminals. The invention clearly applies to systems comprising only multichannel terminals or only single channel terminals, these terminals communicating with interfaces or radio stations as described here or with any other type of communication means.

1. A communication system, comprising at least one local network (21) and terminals (MCTU, SCTU) connected to that network and exchanging data packets (61), each terminal comprising a table (42) storing the addresses of the groups of units with which it can communicate, a unit which transmits a data packet (61) over the network in multicast mode creating a multicast network address (43) the bits of which have a given value (01 00 5E) and which comprises the address (41) of the group to which the data packet is addressed, each terminal comparing the address (41) of the addressee group with the content of its table (42) when the network address (43) has been transmitted over the network, characterized in that the data and the multicast addresses (43) being classified in categories:
each data packet (61) transmitted comprises a tag (63) representing the data category, the received data being analyzed by a receiving terminal according to the value of the tag;
the group addresses (41) are stored in zones (C1, C2, . . . CN) of the table (42) as a function of their categories.

2. The system as claimed in claim 1, characterized in that a software layer (35) analyzes the received data according to the position of their group address (41) in the table (42).

3. The system as claimed in claim 2, characterized in that a data element whose address is not in the expected zone is rejected.

4. The system as claimed in any one of the preceding claims, characterized in that high order bytes of the network address (43) have the given value.

5. The system as claimed in any one of the preceding claims, characterized in that the N low order bits of the group address (41) form the N low order bits of the multicast network address (43).

6. The system as claimed in any one of the preceding claims, characterized in that the group address is a TCP/IP class D address.

7. The system as claimed in any one of the preceding claims, characterized in that a terminal (MCTU, SCTU) analyzes the addresses of the network packets such that, if dealing with the multicast network address (43) comprising the given value (01 00 5E), it compares the group address (41) contained therein with its table (42) and, if not dealing with the address (43) comprising the data value (01 00 5E), it accepts the packet only if this given address (43) corresponds to its physical address.

8. The system as claimed in any one of the preceding claims, characterized in that the network address (43) is analyzed in a software layer (33) implemented in the connection circuit (32) of each terminal.

9. The system as claimed in any one of the preceding claims, characterized in that the packet of transmitted data (61) comprises the port number (62) of the source terminal in addition to the network address (43) and the information (64) to be transmitted.

10. The system as claimed in claim 9, characterized in that a software layer (35) activates an application (36, 37, 38) according to the port number (62) of the source terminal.

11. The system as claimed in any one of the preceding claims, characterized in that it comprises terminals (MCTU) connected to communication elements (Rᵢ) and terminals (SCTU) each connected to a command and control interface (6) for the transmission of the data, one terminal (SCTU) creating the network address (43) according to the instructions received from the interface.

12. The system as claimed in claim 11, characterized in that it comprises data encryption means (KY) connected to terminals for the transmission of secure data, a terminal connected directly to communication means (Rᵢ) never being connected at the same time to encryption means (KY).

13. The system as claimed in claim 16, characterized in that it transports at least two data categories, the data of a first category being sent to the terminals connected to the encryption means.

14. The system as claimed in any one of the preceding claims, characterized in that the given value is 01 00 5E on a hexadecimal base.

15. The system as claimed in any one of the preceding claims, characterized in that it is on board an aircraft.
